(19) United States
(12) Patent Application Publication
(10) Pub. No.: US 2008/0295040 A1
(43) Pub. Date: Nov. 27, 2008

(54) CLOSED CAPTIONS FOR REAL TIME COMMUNICATION

(75) Inventor: Regis J. Crinon, Camas, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/753,277

(22) Filed: May 24, 2007

(51) Int. Cl. G06F 3/00; G06F 15/16

(52) U.S. Cl. 715/865; 709/204

(57) ABSTRACT

The claimed subject matter provides systems and/or methods that facilitate yielding closed caption service associated with real time communication. For example, audio data and video data can be obtained from an active speaker in a real time teleconference. Moreover, the audio data can be converted into a set of characters (e.g., text data) that can be transmitted to other participants of the real time teleconference. Additionally, the real time teleconference can be a peer to peer conference (e.g., where a sending endpoint communicates with a receiving endpoint) and/or a multi-party conference (e.g., where an audio/video multi-point control unit (AVMCU) routes data such as the audio data, the video data, and the text data between endpoints).

### BACKGROUND

Throughout history, technological advancements have enabled simplification of common tasks and/or handling such tasks in more sophisticated manners that can provide increased efficiency, throughput, and the like. For instance, technological advancements have led to automation of tasks oftentimes performed manually, increased ease of widespread dissemination of information, and a variety of ways to communicate as opposed to face to face meetings or sending letters. Moreover, these technological advancements can enhance experiences of individuals with disabilities and/or with limited types of available resources.

In the communication realm, the rise of telecommunications has enabled a shift away from communicating in person or sending written letters; rather, signals (e.g., electromagnetic, . . . ) can be transmitted over a distance for the purpose of carrying data that can be leveraged for communication. Development of the telephone allowed individuals to talk to each other while located at a distance from one another. Additionally, use of fax, email, blogs, instant messaging, and the like has provided a manner by which written language, images, documents, sounds, etc. can be transferred with diminished latencies in comparison to sending letters. Teleconferencing (e.g., audio and/or video conferencing, . . . ) has also allowed for a number of participants positioned at diverse geographic locations to collaborate in a meeting without needing to travel. The aforementioned examples can enable businesses to reduce costs while at the same time increase efficiency.

Participants of teleconferences can have limited access to available resources, disabilities can impact their ability to partake in teleconferences, and so forth. By way of illustration, an individual that takes part in a teleconference can employ a device (e.g., personal computer, laptop, . . . ) that lacks audio output (e.g., speakers, . . . ); accordingly, this individual commonly is unable to understand sounds (e.g., audio data such as spoken language, previously retained audio content, . . . ) transferred as part of the teleconference. According to another example, a participant in a teleconference can be hearing impaired, and thus, can have difficulty associated with joining in the teleconference. Also, a teleconference member can be in a location where she desires to mute her sound to mitigate content of the teleconference being overheard by others in proximity. Conventional techniques, however, oftentimes fail to address the forgoing illustrations.

### SUMMARY

The following presents a simplified summary in order to provide a basic understanding of some aspects described herein. This summary is not an extensive overview of the claimed subject matter. It is intended to neither identify key or critical elements of the claimed subject matter nor delineate the scope thereof. Its sole purpose is to present some concepts in a simplified form as a prelude to the more detailed description that is presented later.

The claimed subject matter relates to systems and/or methods that facilitate yielding closed caption service associated with real time communication. For example, audio data and video data can be obtained from an active speaker in a real time teleconference. Moreover, the audio data can be converted into a set of characters (e.g., text data) that can be transmitted to other participants of the real time teleconference. Additionally, the real time teleconference can be a peer to peer conference (e.g., where a sending endpoint communicates with a receiving endpoint) and/or a multi-party conference (e.g., where an audio/video multi-point control unit (AVMCU) routes data such as the audio data, the video data, and the text data between endpoints).

In accordance with various aspects of the claimed subject matter, text data can be transmitted to listening participants of a real time teleconference to enable rendering of closed captions. For instance, the listening participants can manually and/or automatically negotiate the use of closed captions upon receiving endpoints; thus, the text data can be transmitted to the receiving endpoints that select to utilize closed captions, while the text data need not be transferred to the remaining receiving endpoints. The text data employed for closed captions can be transmitted in compressed forms. Moreover, the text data can be synchronized with the video data and/or the audio data of the teleconference (e.g., via embedding, utilizing timestamps, . . . ). According to another example, when the receiving endpoints select (e.g., automatically, manually, . . . ) to request text data to render closed captions, a language associated with such text data can be chosen as well.

The following description and the annexed drawings set forth in detail certain illustrative aspects of the claimed subject matter. These aspects are indicative, however, of but a few of the various ways in which the principles of such matter may be employed and the claimed subject matter is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a block diagram of an example system that facilitates providing closed captions for real time communications.

FIG. 2 illustrates a block diagram of an example system that generates text data utilized for providing closed captions in real time communications.

FIG. 3 illustrates a block diagram of an example system that effectuates peer to peer real time conferencing.

FIG. 4 illustrates a block diagram of an example system that supports closed captioning in a real time multi-party conference.

FIG. 5 illustrates a block diagram of an example system that enables closed captioning to be employed in connection with real time conferencing.

FIG. 6 illustrates a block diagram of an example system that enables synchronizing various types of data (e.g., audio, video, text, . . . ) during a real time teleconference.

FIG. 7 illustrates a block diagram of an example system that infers whether to generate and/or transmit a text stream associated with audio data from a real time teleconference.

FIG. 8 illustrates an example methodology that facilitates providing closed caption service associated with real time communications.

FIG. 9 illustrates an example methodology that facilitates routing data between endpoints in a multi-party real time conference.

FIG. 10 illustrates an example networking environment, wherein the novel aspects of the claimed subject matter can be employed.

FIG. 11 illustrates an example operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” and the like are intended to refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips, . . . ), optical disks (e.g., compact disk (CD), digital versatile disk (DVD), . . . ), smart cards, and flash memory devices (e.g., card, stick, key drive, . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

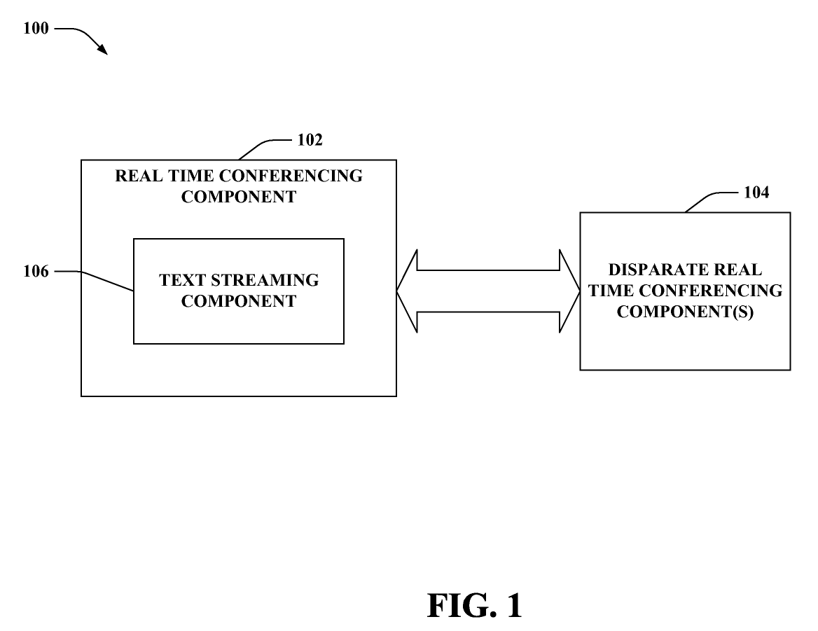

Now turning to the figures, FIG. 1 illustrates a system 100 that facilitates providing closed captions for real time communications. The system 100 includes a real time conferencing component 102 that can communicate with any number of disparate real time conferencing component(s) 104. It is to be appreciated that the real time conferencing component 102 (and/or the disparate real time conferencing component(s) 104) can be an endpoint (e.g., sending endpoint, receiving endpoint), an audio/video multi-point control unit (AVMCU), included within and/or coupled to an endpoint or an AVMCU, and so forth. For instance, such endpoints can be personal computers, cellular phones, smart phones, laptops, handheld communication devices, handheld computing devices, gaming devices, personal digital assistants (PDAs), dedicated teleconferencing systems, consumer products, automobiles, and/or any other suitable devices. Moreover, the AVMCU can be a bridge that interconnects several endpoints and enables routing data between the endpoints.

The real time conferencing component 102 can send and/or receive data (e.g., via a network such as the internet, a corporate intranet, a telephone network, . . . ) utilized in connection with audio/video teleconferences. For instance, the real time conferencing component 102 can transmit and/or obtain audio data, video data, text data, and so forth. Further, the real time conferencing component 102 and the disparate real time conferencing component(s) 104 can leverage various adaptors, connectors, channels, communication paths, etc. to enable interaction there between.

The system 100 can support real time peer-to-peer conferences and/or multi-party conferences. For example, in a peer-to-peer conference, the real time conferencing component 102 and the disparate real time conferencing component 104 can both be endpoints that can directly communicate with each other (e.g., over a network connection, . . . ). Moreover, in a multi-party conference, data can traverse through an AVMCU, which can be a gateway between substantially any number of endpoints; according to this illustration, the real time conferencing component 102 and/or the disparate real time conferencing components(s) 104 can be endpoints, AVMCUs, and the like.

The real time conferencing component 102 can further include a text streaming component 106 that can generate, transfer, route, receive, output, etc. streaming text (e.g., text data) utilized to yield closed captions associated with a real time audio/video conference. For example, when the real time conferencing component 102 is a receiving endpoint, the text streaming component 106 can obtain and output text (e.g., upon a display, . . . ), where the text can correspond to audio data yielded by an active speaker at a particular time. The text can be overlaid over video associated with the real time conference concurrently being outputted and/or in an area above, below, to the side of, etc. the video, for instance. Moreover, when the real time conferencing component 102 is a sending endpoint, the text streaming component 106 can transmit the text stream and/or audio data that can be converted into the text stream (e.g., by the disparate real time conferencing component(s) 104).

The system 100 can enable providing closed caption service with real time communications. For instance, participants in a real time conference who have muted their respective speakers and still want to know what is being said on the conference can leverage the closed caption service. Moreover, participants who have poor or no hearing yet still desire to participate in an audio/video conference can employ the system 100.

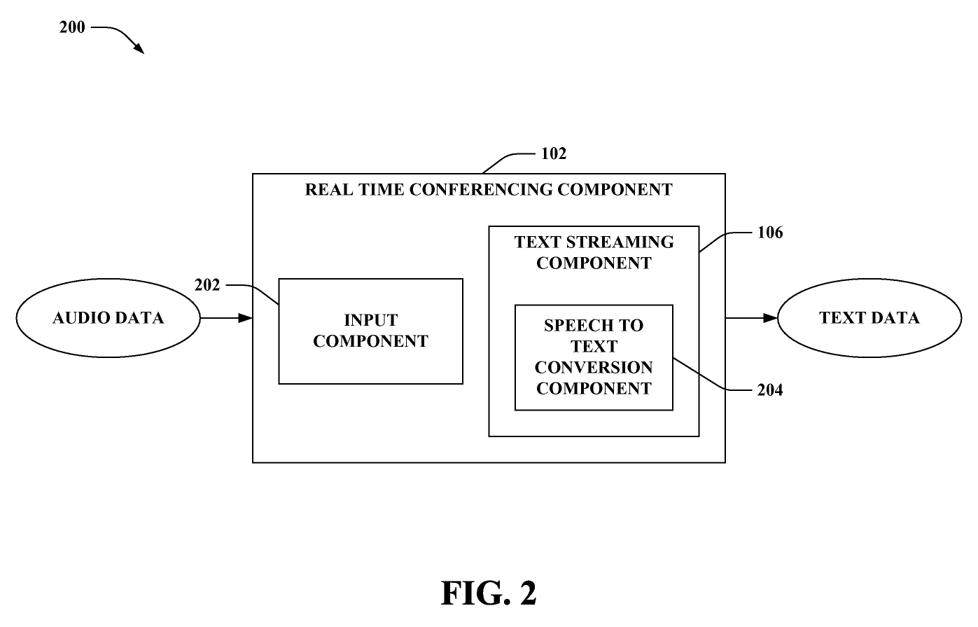

With reference to FIG. 2, illustrated is a system 200 that generates text data utilized for providing closed captions in real time communications. The system 200 includes the real time conferencing component 102 that can obtain audio data as an input and yield text data as an output. The real time conferencing component 102 can further comprise the text streaming component 106 and an input component 202 that can obtain the audio data. Moreover, it is contemplated that the real time conferencing component 102 (e.g., via the input component 202) can receive video data (not shown) along with the audio data.

The input component 202 can obtain the audio data in any manner. According to an illustration, the input component 202 can convert waves in air, water or hard material and translate them into an electrical signal. For example, the input component 202 can be a microphone that can capture the audio data and generate electrical impulses. Further, the input component 202 can be a sound card that can convert acoustical signals to digital signals. In accordance with another example, the input component 202 can obtain audio data captured by and thereafter transmitted from a disparate real time conferencing component (not shown). Thus, the audio data can be transferred via a network connection and obtained by the input component 202.

The text streaming component 106 can further include a speech to text conversion component 204 that converts the audio data to text data. The speech to text conversion component 204 can employ a speech recognition engine that can convert digital signals corresponding to the audio data to phonemes, words, and so forth. Moreover, the speech to text conversion component 204 can process continuous speech and/or isolated or discrete speech. For continuous speech, the speech to text conversion component 204 can convert audio data spoken naturally at a conversational speed. Additionally, isolated or discrete speech entails processing audio data where a speaker pauses between each word. The speech to text conversion component 204 can provide real time conversion of speech of an active speaker into a set of characters that can be transmitted to other participants for the purpose of real time communication. The set of characters (e.g., text data) can be employed for closed captions and can be transmitted in a compressed form. Moreover, the text data can be sent to endpoints requesting such data.

The speech to text conversion component 204 can compare processed words to a dictionary of words associated therewith. For example, the dictionary of words can be retained in memory (not shown). Moreover, the dictionary of words can be predefined and/or can be trainable. By way of illustration, users can each be associated with respective profiles that include information related to their unique speech patterns, and these profiles can be utilized in the matching process during recognition. The profiles can provide information pertaining to the user's accent, language, vocabulary (e.g., dictionary of words), enunciation, pronunciation, and the like. Thus, for instance, the profile can include a user's list of recognized words, and the speech to text conversion component 204 can compare the audio data to the recognized words to yield the text data.

According to another illustration, the speech to text conversion component 204 (and/or a translation component (not shown)) can translate audio data into text data in one or more foreign languages. For instance, the speech to text conversion component 204 can convert audio data into text data in a first language. Thereafter, the text data in the first language can be translated into any number of disparate languages. Thus, one or more text streams can be transmitted, where each text stream can correspond to a specific language. Moreover, an endpoint that receives the text data (e.g., a receiving endpoint) can enable selecting a desired language; accordingly, the text stream associated with the selected language can be sent to such receiving endpoint (e.g., from the sending endpoint, an AVMCU, . . . ).

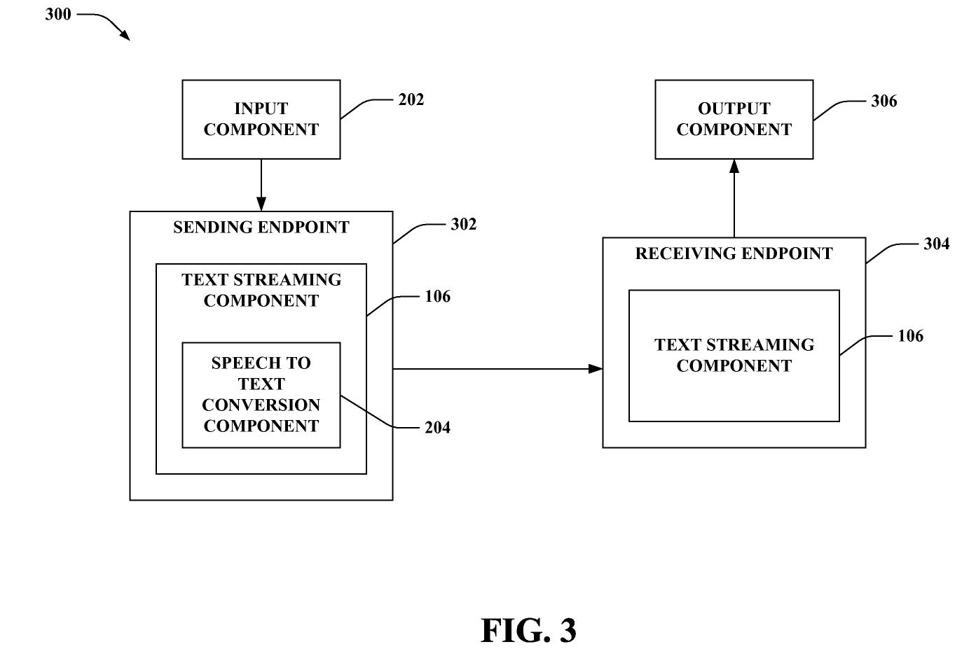

Now turning to FIG. 3, illustrated is a system 300 that effectuates peer to peer real time conferencing. The system 300 includes a sending endpoint 302 that communicates with a receiving endpoint 304. The sending endpoint 302 can be the real time conferencing component 102 (and/or one of the disparate real time conferencing component(s) 104) described herein (and similarly the receiving endpoint 304 can be the real time conferencing component 102 and/or one of the disparate real time conferencing component(s) 104). The sending endpoint 302 can transfer audio data, video data, and/or text data directly to the receiving endpoint 304 via a network connection (e.g., over the Internet, an intranet, a telephone network, . . . ). In the case of peer to peer conferencing between two endpoints, one endpoint (e.g., the sending endpoint 302) can be utilized by an active speaker at a particular time and the other endpoint (e.g., the receiving endpoint 304) can receive data from the active speaker via the sending endpoint 302 at that particular time. Moreover, at a different instance in time, the role of the endpoints can switch such that the other endpoint (e.g., the receiving endpoint 304 at the previous particular time) can be associated with the active speaker, and therefore, can be the sending endpoint while the endpoint that sent data at the previous particular time can be the receiving endpoint.

Further, the sending endpoint 302 can obtain data from the input component 202 while the sending endpoint 302 is associated with the active speaker. It is to be appreciated that the input component 202 can be separate from the sending endpoint 302, the sending endpoint 302 can include the input component 202 (not shown), a combination thereof, and so forth. The input component 202 can obtain any type of input. For example, the input component 202 can obtain audio data and/or video data from a participant in a teleconference (e.g., the active speaker). Following this example, the input component 202 can include a video camera to capture video data and/or a microphone to obtain the audio input. According to another illustration, the input component 202 can include memory (not shown) that can retain documents, sounds, images, videos, etc. that can be provided to the sending endpoint 302 for transfer to the receiving endpoint 304. Thus, slides from a presentation can be sent from the sending endpoint 302 to the receiving endpoint 304, for example.

The sending endpoint 302 can further include the text streaming component 106 that communicates text data to the receiving endpoint 304 (e.g., the text streaming component 106 of the receiving endpoint 304). The text streaming component 106 of the sending endpoint 302 can further comprise the speech to text conversion component 204 that converts digital audio data obtained by way of the input component 202 into the text data that can be utilized to generate closed captions. Further, it is contemplated that the speech to text conversion component 204 need not be included in the sending endpoint 302 (and/or in the text streaming component 106); rather, the speech to text conversion component 204 can be a stand alone component, for instance. Moreover, it is to be appreciated that the receiving endpoint 304 can be associated with a substantially similar speech to text conversion component (not shown); thus, such substantially similar speech to text component can be utilized when the roles of the receiving endpoint 304 and the sending endpoint 302 switch at a disparate time (e.g., the receiving endpoint 304 changes to a sending endpoint associated with an active speaker and the sending endpoint 302 changes to a receiving endpoint). According to another example, the sending endpoint 302 can transmit audio data to the receiving endpoint 304, and the substantially similar speech to text conversion component of the receiving endpoint 304 can convert the audio data into text data to yield closed captions; it is to be appreciated, however, that the claimed subject matter is not so limited.

The receiving endpoint 304 can be coupled to an output component 306 that yields outputs corresponding to the audio data, video data, text data, etc. received from the sending endpoint 302. For example, the output component 306 can include a display (e.g., monitor, television, projector, . . . ) to present video data and/or text data. Moreover, the output component 306 can comprise one or more speakers to render audio output.

According to an example, the output component 306 can provide various types of user interfaces to facilitate interaction between a user and the receiving endpoint 304. As depicted, the output component 304 is a separate entity that can be utilized with the receiving endpoint 304. However, it is to be appreciated that the output component 306 can be incorporated into the receiving endpoint 304 and/or a stand-alone unit. The output component 306 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed.

The user can also interact with the regions to select and provide information via various devices such as a mouse, a roller ball, a keypad, a keyboard, a pen and/or voice activation, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can than provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels. Although not shown, it is contemplated that the sending endpoint 302 can be associated with an output component substantially similar to the output component 306 and the receiving endpoint 304 can be associated with an input component substantially similar to the input component 202.

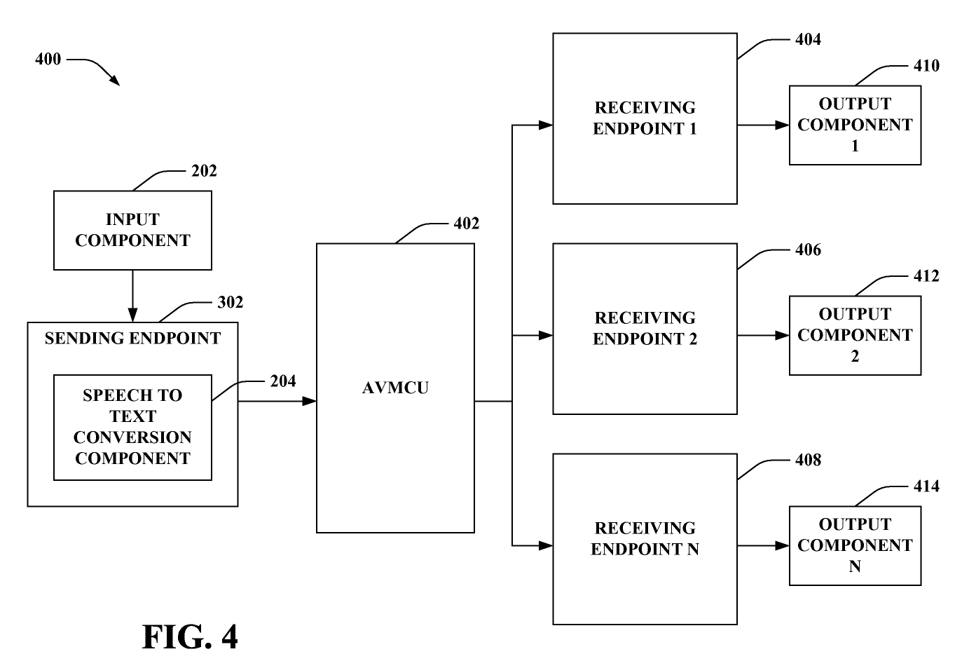

Turning to FIG. 4, illustrated is a system 400 that supports closed captioning in a real time multi-party conference. The system 400 includes the sending endpoint 302 that can obtain audio data, video data, etc. for transfer by way of the input component 202. The system 400 can additionally include an audio/video multi-point control unit (AVMCU) 402 and any number of receiving endpoints (e.g., a receiving endpoint 1 404, a receiving endpoint 2 406, . . . , a receiving endpoint N 408, where N can be substantially any integer). Moreover, each of the receiving endpoints 404-408 can be associated with a corresponding output component (e.g., an output component 1 410 can be associated with the receiving endpoint 1 404, an output component 2 412 can be associated with the receiving endpoint 2 406, . . . , an output component N 414 can be associated with the receiving endpoint N 408). The sending endpoint 302 and the receiving endpoints 404-408 can be substantially similar to the aforementioned description. Moreover, it is contemplated that the sending endpoint 302, the AVMCU 402, and/or the receiving endpoints 404-408 can include the text streaming component 106 described above.

One person (e.g., an active speaker associated with the sending endpoint 302) can present at a particular time and the remaining participants in a conference can listen (e.g., multitask by turning off the audio while monitoring what is being said via closed captioning, associated with the receiving endpoints 404-408 . . . ). Additionally, at the time of an interruption, the person that was the active speaker prior to the interruption no longer is associated with the sending endpoint 302; rather, the interrupting party becomes associated with the sending endpoint 302. In an interactive conference where speakers can alternate, the AVMCU 402 can identify the active speaker at a particular time. Moreover, the AVMCU 402 can route data to non-speaking participants. Further, when the active speaker changes, the AVMCU 402 can alter the routing to account for such changes.

According to the illustrated example, the sending endpoint 302 can include the speech to text conversion component 204. Alternatively, the speech to text conversion component 204 can be coupled to the sending endpoint 302 (not shown). The sending endpoint 302 can be associated with an active speaker at a particular time. Thus, the sending endpoint 302 can receive audio data and video data for a real time conference from the input component 202, and the speech to text conversion component 204 can generate text data corresponding to the audio data. Thereafter, the sending endpoint 302 can send audio data, video data and text data to the AVMCU 402. Pursuant to another example, the sending endpoint 302 can select whether to disable or enable the ability of receiving endpoints 404-408 to obtain the text data for closed captioning; hence, if closed captioning is disabled, the sending endpoint 302 can sent audio data and video data to the AVMCU 402 without text data, for instance.

The AVMCU 402 can obtain the audio data, video data and text data from the sending endpoint 302. Further, the AVMCU 402 can route such data to the receiving endpoints 404-408. Thereafter, the output components 410-414 corresponding to each of the receiving endpoints 404-408 can generate respective outputs. It should be noted that the AVMCU 402 can mix the audio of several active audio sources in which case, the audio stream sent to receiving endpoints 404-408 represents a combination of all active speakers (double or triple talk, or one dominant speaker with other participants contributing noise, for example). In this case, the AVMCU 402 can elect to send the text stream associated with the dominant speaker only or it may elect to send several text streams, each corresponding to one active speech track. Whether one or the other is used could be presented as a configuration parameter in the AVMCU 402.

According to an example, the AVMCU 402 can transmit the audio data, video data and text data to each of the receiving endpoints 404-408. Pursuant to another example, the AVMCU 402 can send the video data to each of the receiving endpoints 404-408 along with either the audio data or the text data. For instance, the AVMCU 402 can send the text data for closed captions to the receiving endpoints 404-408 requesting such data. Thus, the AVMCU 402 can send video data and audio data to the receiving endpoint 1 404 and video data and text data to the receiving endpoint 2 406 and the receiving endpoint N 408, for example.

Participants can manually negotiate the use of closed captions and/or the receiving endpoints 404-408 used by the listening participants can automatically negotiate the transmission of closed captions with the AVMCU 402 (or the sender in the peer to peer case described in connection with FIG. 3). In the manual negotiation scenario, the participant employing each of the receiving endpoints 404-408 can select whether closed captions are desired, and this selection can cause a request to be sent to the AVMCU 402. For example, if the receiving endpoint 2 406 provides a request to enable closed captioning, the AVMCU 402 can forward text data to the receiving endpoint 2 406 while continuing to transmit the audio data to the receiving endpoint 1 404 (e.g., an endpoint that has not selected closed captioning). Moreover, according to the automatic scenario, the receiving endpoints 404-408 can automatically negotiate for transmission of text or audio by the AVMCU 402. Hence, a speaker (e.g., the output component N 414) associated with the receiving endpoint N 408 can be muted, and thus, the receiving endpoint N 408 can automatically request that the AVMCU 402 send text data to enable closed captions to be presented as an output. The action can be triggered in the receiving endpoint N 408 by a mute button on a user interface, for instance. In response to the request, the AVMCU 402 can halt sending of the audio data to the receiving endpoint N 408, and the text data can be transmitted instead with the video data. By way of another illustration, a user's context, location, schedule, state, characteristics, preferences, profile, and the like can be utilized to discern whether to automatically request text data and/or audio data. The examples mentioned above can be extended to the case where there are multiple concurrent active speakers in the conference and text streams are available for each of these participants in which case manual selection can include the choice of which closed captions stream is selected for viewing in the receiving endpoint.

By transmitting either text data or audio data, the AVMCU 402 can improve overall efficiency since a large number of participants in a conference can be supported by the system 400. Hence, more participants can leverage the system 400 by communicating text data or audio data to each of the receiving endpoints 404-408 to mitigate an impact of bandwidth constraints. However, it is contemplated that both text data and audio data can be sent from the AVMCU 402 to one or more of the receiving endpoints 404-408.

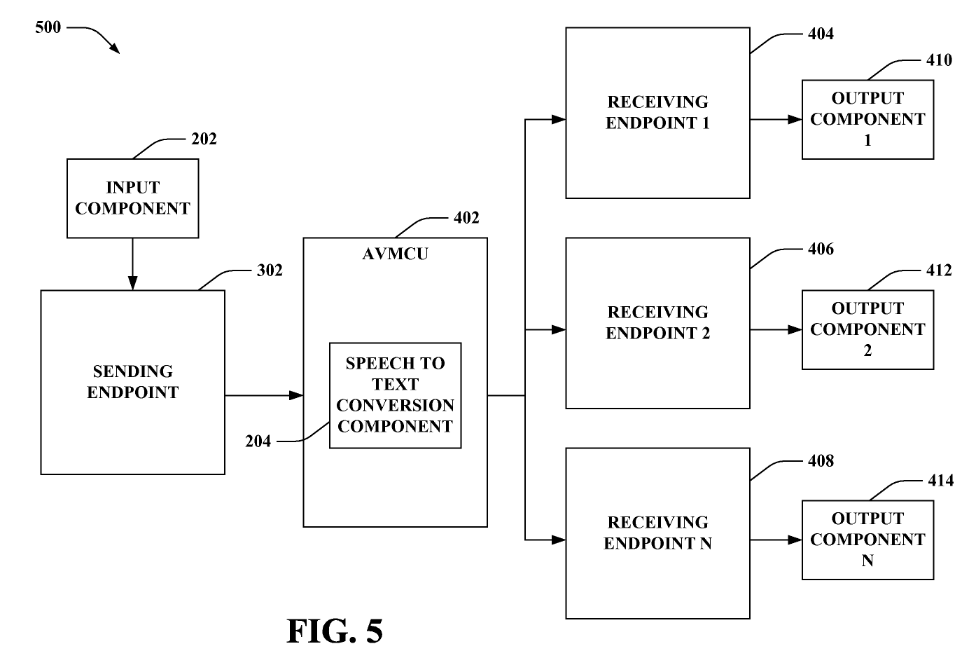

Referring to FIG. 5, illustrated is a system 500 that enables closed captioning to be employed in connection with real time conferencing. The system 500 can include the input component 202, the sending endpoint 302, the AVMCU 402, the receiving endpoints 404-408 and the output components 410-414 as described above. Further, the AVMCU 402 can include the speech to text conversion component 204 (rather than being included in the sending endpoint 302 as depicted in FIG. 4). Alternatively, it is contemplated that the speech to text conversion component 204 can be separate from AVMCU 402 (not shown).

Pursuant to the example shown in FIG. 5, the sending endpoint 302 can transfer audio data and video data to the AVMCU 402. The speech to text conversion component 204 associated with the AVMCU 402 can thereafter produce text data from the received audio data. Moreover, the AVMCU 402 can send the audio data, text data, and/or video data to the receiving endpoints 404-408 in accordance with the aforementioned description.

By way of another illustration, one or more of the receiving endpoints 404-408 can archive the content sent from the AVMCU 402 (and/or the AVMCU 402 can archive such content). It is to be appreciated that archiving can be employed in connection with any of the examples described herein and is not limited to being utilized by the system 500 of FIG. 5. For example, the receiving endpoint 1 404 can retain the audio data, text data, and/or video data within a data store (not shown) associated therewith. It is to be appreciated that any number of data stores can be employed by the receiving endpoint 1 404 (and/or the receiving endpoints 406-408 and/or the sending endpoint 302 and/or the AVMCU 402) and the data stores can be centrally located and/or positioned at differing geographic locations. By way of another example, text data received from the AVMCU 402 can be retained in the data store associated with the receiving endpoint 1 404 to generate a transcript of a teleconference, and this transcript can be saved as a document, posted on a blog, emailed to participants of the conference, and so forth.

The data store can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store of the subject systems and methods is intended to comprise, without being limited to, these and any other suitable types of memory. In addition, it is to be appreciated that the data store can be a server, a database, a hard drive, and the like.

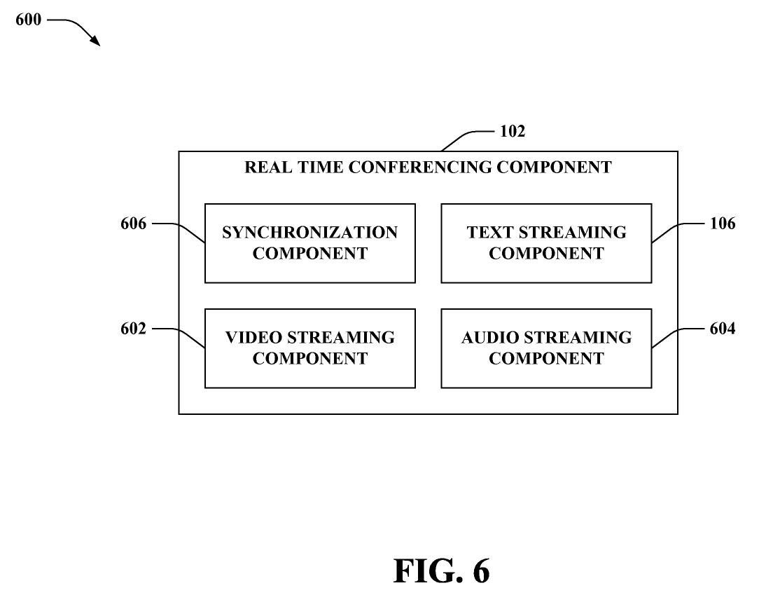

With reference to FIG. 6, illustrated is a system 600 that enables synchronizing various types of data (e.g., audio, video, text, . . . ) during a real time teleconference. The system 600 includes the real time conferencing component 102, which can further comprise the text streaming component 106. The real time conferencing component 102 can additionally include a video streaming component 602, an audio streaming component 604, and a synchronization component 606. The video streaming component 602 can generate, transfer, obtain, process, output, etc. video data (e.g., a video stream) obtained from an active speaker and the audio streaming component 604 can generate, transfer, obtain, process, output, etc. audio data (e.g., an audio stream) obtained from the active speaker. Moreover, the synchronization component 606 can correlate the text data, audio data, and video data in time for presentation to listening participants in the real time teleconference.

According to an example, the synchronization component 606 can effectuate synchronizing the data by embedding text data in video streams. For instance, common video compression standards can include placeholders in the bit streams for inserting independent streams of bits associated with disparate types of data. Hence, the synchronization component 606 can encode and/or decode sections of text data that can be periodically inserted in a video bit stream. Insertion of text data in the video data can enable partitioned sections of text data to be synchronized with the video frames (e.g., a section of the text data can be sent with a video frame). Moreover, the partitioning of the text data can be accomplished subsequent to yielding a text string (e.g., obtained from speech to text conversion, included with slides in a presentation, . . . ). Thus, the text can be embedded in placeholders in the bit stream associated with the video data, where the placeholders can be part of the data representing a video frame. Further, by embedding the text data, synchronization can be captured implicitly because the text data can be part of the metadata associated with a video frame. Thus, at a receiving endpoint (e.g., the real time conferencing component 102, the receiving endpoint 304 of FIG. 3, the receiving endpoints 404-408 of FIGS. 4 and 5, . . . ), when a video frame is received, data can be decoded to render the video frame while the metadata including the text can also be decoded to render closed captions on a screen with the corresponding video frame.

Pursuant to another illustration, the synchronization component 606 can employ timestamps to synchronize data (e.g., audio, video, text, . . . ). For example, the timestamps can be in the real time transport protocol (RTP) used by real time communication systems. Separate streams of data including timestamps can be generated (e.g., at a sending endpoint, an AVMCU, . . . ), and the streams can be multiplexed over the RTP. Moreover, the receiving endpoints can utilize timestamps to identify correlation between data within the separate streams.

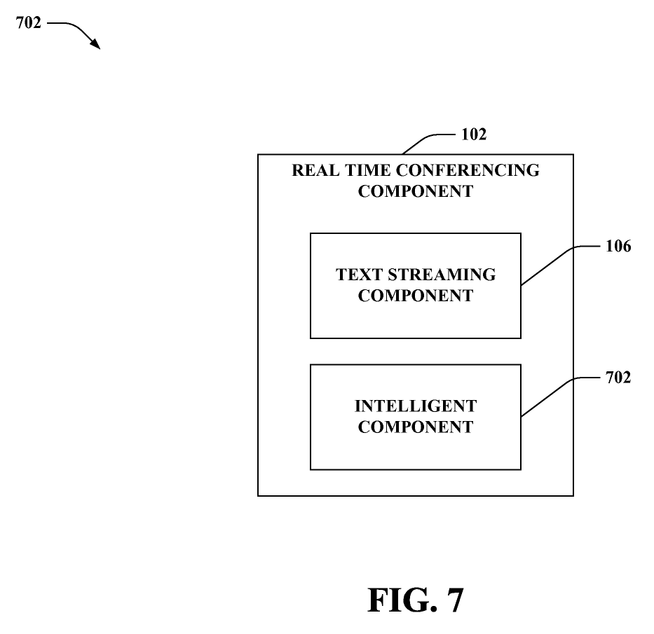

Turning to FIG. 7, illustrated is a system 700 that infers whether to generate and/or transmit a text stream associated with audio data from a real time teleconference. The system 700 can include the real time conferencing component 102 that can further comprise the text streaming component 106, each of which can be substantially similar to respective components described above. The system 700 can further include an intelligent component 702. The intelligent component 702 can be utilized by the real time conferencing component 102 to reason about a whether to convert audio data into text data. Further, the intelligent component 702 can evaluate a context, state, situation, etc. associated with the real time conferencing component 102 and/or a disparate real time conferencing component (not shown) and/or a network (not shown) to infer whether to transmit audio data and/or text data (e.g., data that can be leveraged in connection with yielding closed captions).

It is to be understood that the intelligent component 702 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

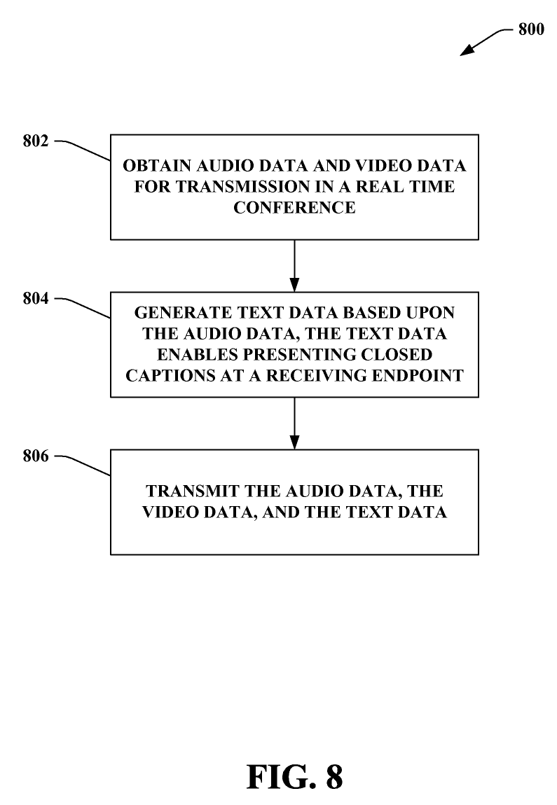

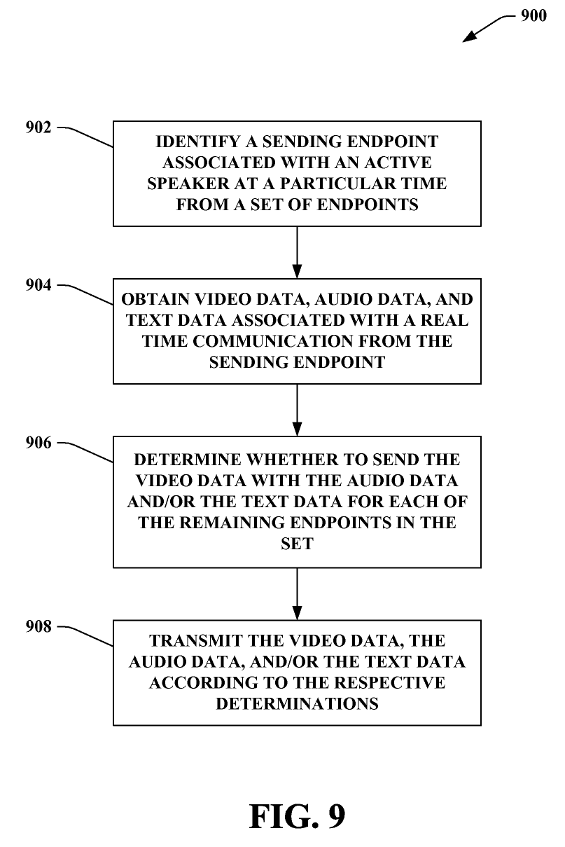

FIGS. 8-9 illustrate methodologies in accordance with the claimed subject matter. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events.

With reference to FIG. 8, illustrated is a methodology 800 that facilitates providing closed caption service associated with real time communications. At 802, audio data and video data can be obtained for transmission in a real time conference. For example, the audio data and the video data can be received from an active speaker. At 804, text data can be generated based upon the audio data, where the text data enables presenting closed captions at a receiving endpoint. Thus, the audio data (e.g., audio stream) can be converted into a stream of text characters. Moreover, the text data, audio data, and/or video data can be synchronized (e.g., by embedding text data in a bit stream associated with video data, utilizing timestamps, . . . ). At 806, the audio data, the video data, and the text data can be transmitted. For instance, the data can be transmitted to a disparate endpoint in a peer-to-peer conference. According to another example, the audio data, the video data, and the text data can be sent to an audio/video multi-point control unit (AVMCU) (e.g., for a multi-party conference, . . . ). Moreover, it is contemplated that the audio data and the video data can be transmitted to the AVMCU, which can thereafter generate the text data.

Now turning to FIG. 9, illustrated is a methodology 900 that facilitates routing data between endpoints in a multi-party real time conference. At 902, a sending endpoint (or several sending endpoints) associated with an active speaker (active speakers) at a particular time can be identified from a set of endpoints. It is to be appreciated that substantially any number of endpoints can be included in the set of endpoints. Moreover, disparate endpoints can be determined to be associated with an active speaker at differing times. Further, the sending endpoint can continuously, periodically, etc. be determined. At 904, video data, audio data, and text data associated with a real time communication can be obtained from the sending endpoint. According to an example, the text data can be obtained from the sending endpoint upon such data being generated by the sending endpoint based upon the audio data. By way of another illustration, the audio data can be received from the sending endpoint, and the audio data can be converted to yield the text data utilized to provide closed captions.

At 906, a determination can be effectuated concerning whether to send the video data with the audio data and/or the text data for each of the remaining endpoints in the set. For example, each of the receiving endpoints can manually and/or automatically negotiate the transmission of audio data (e.g., for outputting via a speaker) and/or text data (e.g., for outputting via a display in the form of closed captions). By way of illustration, a request for text data can be obtained from a receiving endpoint in response to muting of a speaker associated with the receiving endpoint. At 908, the video data, the audio data, and/or the text data can be transmitted according to the respective determinations.

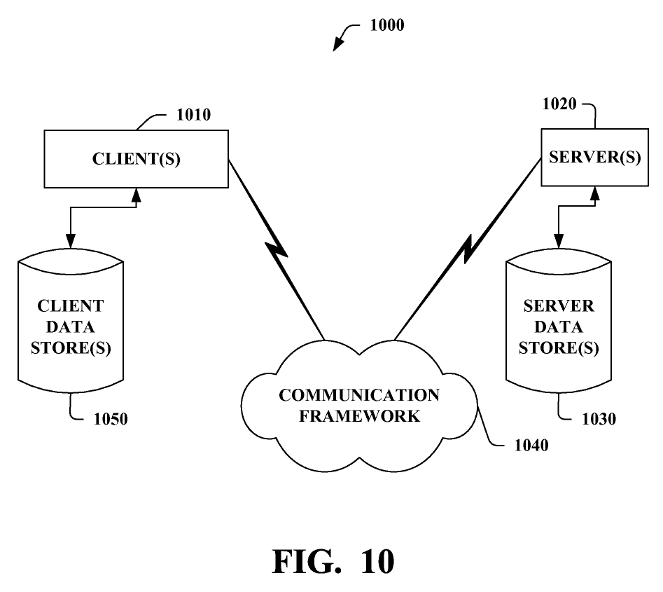

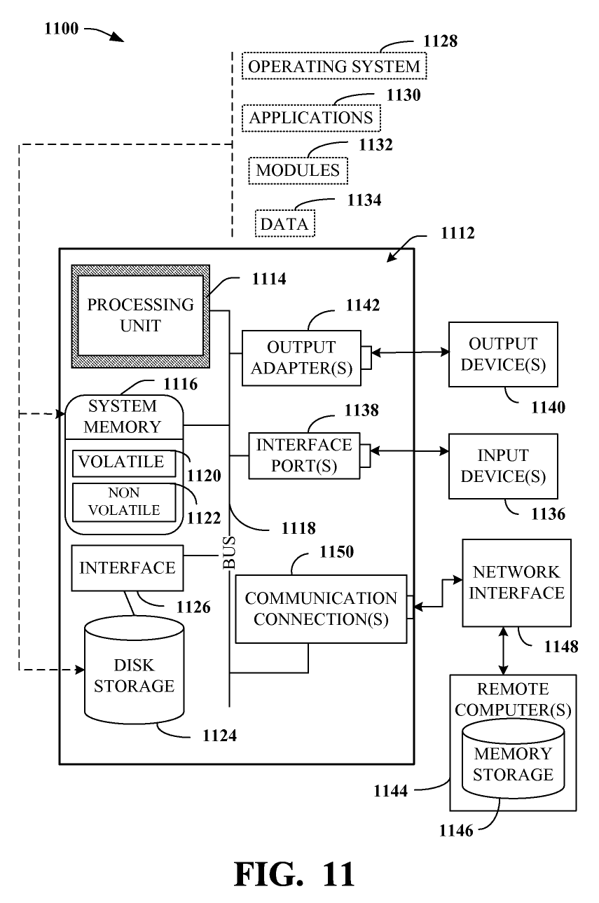

In order to provide additional context for implementing various aspects of the claimed subject matter, FIGS. 10-11 and the following discussion is intended to provide a brief, general description of a suitable computing environment in which the various aspects of the subject innovation may be implemented. For instance, FIGS. 10-11 set forth a suitable computing environment that can be employed in connection with generating text data and/or outputting such data for closed captions associated with a real time conference. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 10 is a schematic block diagram of a sample-computing environment 1000 with which the claimed subject matter can interact. The system 1000 includes one or more client(s) 1010. The client(s) 1010 can be hardware and/or software (e.g., threads, processes, computing devices). The system 1000 also includes one or more server(s) 1020. The server(s) 1020 can be hardware and/or software (e.g., threads, processes, computing devices). The servers 1020 can house threads to perform transformations by employing the subject innovation, for example.

One possible communication between a client 1010 and a server 1020 can be in the form of a data packet adapted to be transmitted between two or more computer processes. The system 1000 includes a communication framework 1040 that can be employed to facilitate communications between the client(s) 1010 and the server(s) 1020. The client(s) 1010 are operably connected to one or more client data store(s) 1050 that can be employed to store information local to the client(s) 1010. Similarly, the server(s) 1020 are operably connected to one or more server data store(s) 1030 that can be employed to store information local to the servers 1020.

With reference to FIG. 11, an exemplary environment 1100 for implementing various aspects of the claimed subject matter includes a computer 1112. The computer 1112 includes a processing unit 1114, a system memory 1116, and a system bus 1118. The system bus 1118 couples system components including, but not limited to, the system memory 1116 to the processing unit 1114. The processing unit 1114 can be any of various available processors. Dual microprocessors and other multiprocessor architectures also can be employed as the processing unit 1114.

The system bus 1118 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1116 includes volatile memory 1120 and nonvolatile memory 1122. The basic input/output system (BIOS), containing the basic routines to transfer information between elements within the computer 1112, such as during start-up, is stored in nonvolatile memory 1122. By way of illustration, and not limitation, nonvolatile memory 1122 can include read only memory (ROM), programmable ROM (PROM), electrically programmable ROM (EPROM), electrically erasable programmable ROM (EEPROM), or flash memory. Volatile memory 1120 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1112 also includes removable/non-removable, volatile/non-volatile computer storage media. FIG. 11 illustrates, for example a disk storage 1124. Disk storage 1124 includes, but is not limited to, devices like a magnetic disk drive, floppy disk drive, tape drive, Jaz drive, Zip drive, LS-100 drive, flash memory card, or memory stick. In addition, disk storage 1124 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1124 to the system bus 1118, a removable or non-removable interface is typically used such as interface 1126.

It is to be appreciated that FIG. 11 describes software that acts as an intermediary between users and the basic computer resources described in the suitable operating environment 1100. Such software includes an operating system 1128. Operating system 1128, which can be stored on disk storage 1124, acts to control and allocate resources of the computer system 1112. System applications 1130 take advantage of the management of resources by operating system 1128 through program modules 1132 and program data 1134 stored either in system memory 1116 or on disk storage 1124. It is to be appreciated that the claimed subject matter can be implemented with various operating systems or combinations of operating systems.

A user enters commands or information into the computer 1112 through input device(s) 1136. Input devices 1136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1114 through the system bus 1118 via interface port(s) 1138. Interface port(s) 1138 include, for example, a serial port, a parallel port, a game port, and a universal serial bus (USB). Output device(s) 1140 use some of the same type of ports as input device(s) 1136. Thus, for example, a USB port may be used to provide input to computer 1112, and to output information from computer 1112 to an output device 1140. Output adapter 1142 is provided to illustrate that there are some output devices 1140 like monitors, speakers, and printers, among other output devices 1140, which require special adapters. The output adapters 1142 include, by way of illustration and not limitation, video and sound cards that provide a means of connection between the output device 1140 and the system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. The remote computer(s) 1144 can be a personal computer, a server, a router, a network PC, a workstation, a microprocessor based appliance, a peer device or other common network node and the like, and typically includes many or all of the elements described relative to computer 1112. For purposes of brevity, only a memory storage device 1146 is illustrated with remote computer(s) 1144. Remote computer(s) 1144 is logically connected to computer 1112 through a network interface 1148 and then physically connected via communication connection 1150. Network interface 1148 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1150 refers to the hardware/software employed to connect the network interface 1148 to the bus 1118. While communication connection 1150 is shown for illustrative clarity inside computer 1112, it can also be external to computer 1112. The hardware/software necessary for connection to the network interface 1148 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates providing closed captions for real time communications, comprising:
a real time conferencing component that communicates with at least one disparate real time conferencing component; and
a text streaming component that transmits text data utilized to render closed captions associated with a real time teleconference from the real time conferencing component to the at least one disparate real time conferencing component, the text data corresponding to audio data of the real time teleconference.

2. The system of claim 1, further comprising a speech to text conversion component that converts the audio data into the text data in real time.

3. The system of claim 2, further comprising a translation component that translates the text data from a first language into one or more disparate languages.

4. The system of claim 1, the text streaming component transmits the text data in a compressed form.

5. The system of claim 1, further comprising:
a video streaming component that transmits video data to the at least one disparate real time conferencing component; and
an audio streaming component that transmits audio data with the at least one disparate real time conferencing component.

6. The system of claim 5, further comprising a synchronization component that correlates the text data, the video data, and the audio data in time for presentation to listening participants in the real time teleconference, the synchronization component at least one of embeds the text data in the video data or employs timestamps with multiplexed streams associated with the text data, the video data, and the audio data.

7. The system of claim 1, the real time conferencing component negotiates with the at least one disparate real time conferencing component as to whether to transmit video data with the text data or the audio data.

8. The system of claim 1, the real time conferencing component transmits the text data to the at least one disparate real time conferencing component when the at least one real time conferencing component requests the text data.

9. The system of claim 1, the real time teleconference being a peer to peer conference where the real time conferencing component is a sending endpoint and the at least one disparate real time conferencing component is a receiving endpoint.

10. The system of claim 1, the real time teleconference being a multi-party conference where the real time conferencing component is a sending endpoint or an audio/video multi-point control unit (AVMCU) and the at least one disparate real time conferencing component is the AVMCU or a receiving endpoint.

11. The system of claim 10, the sending endpoint or the AVMCU further comprises a speech to text conversion component that converts the audio data into the text data.

12. The system of claim 1, the text streaming component transmits a text stream associated with a dominant speaker when a plurality of speakers are concurrently active or transmits a plurality of text streams corresponding with each of the concurrently active speakers.

13. A method that facilitates routing data between endpoints in a multi-party real time conference, comprising:
identifying a sending endpoint associated with an active speaker at a particular time from a set of endpoints;
obtaining video data, audio data, and text data associated with a real time communication from the sending endpoint;
determining whether to send the video data with the audio data and/or the text data for each of the remaining endpoints in the set; and
transmitting the video data, the audio data, and/or the text data according to the respective determinations.

14. The method of claim 13, further comprising identifying disparate endpoints from the set as being associated with the active speaker at differing times.

15. The method of claim 13, further comprising obtaining the text data from the sending endpoint upon the text data being generated by the sending endpoint based upon the audio data.

16. The method of claim 13, further comprising converting the audio data into the text data in real time.

17. The method of claim 13, further comprising receiving a request for the text data from at least one of the remaining endpoints in the set.

18. The method of claim 17, the request being received in response to an output component associated with the at least one remaining endpoints being muted.

19. The method of claim 13, further comprising transmitting the text data in a selected language.

20. A system that provides closed caption service associated with real time communications, comprising:
means for obtaining audio data and video data for transmission in a real time conference;
means for generating text data based upon the audio data, the text data enables presenting closed captions at a receiving endpoint; and
means for transmitting the audio data, the video data, and the text data.
